(19) United States
(12) Patent Application Publication
(10) Pub. No.: US 2009/0105908 A1
(43) Pub. Date: Apr. 23, 2009

(54) Apparatus and Method for Controlling Vehicle Motion

(75) Inventors: Robert Casey, Saugus, MA (US); Michael T. Gansler, Candia, NH (US); John B. Morrell, Hamden, CT (US); Michael F. Kaufman, New Boston, NH (US); Jon M. Stevens, Manchester, NH (US)

Correspondence Address: PROSKAUER ROSE LLP, ONE INTERNATIONAL PLACE, BOSTON, MA, 02110, US

(73) Assignee: Segway Inc., Bedford, NH (US)

(21) Appl. No.: 12/254,178

(22) Filed: Oct. 20, 2008

Related U.S. Application Data
(60) Provisional application No. 60/981,145, filed on Oct. 19, 2007.

(51) Int. Cl. B62D 6/00

(52) U.S. Cl. 701/41

(57) ABSTRACT

An apparatus and method for controlling a steering command of a vehicle is provided. A deadband value based on a current state of a transporter is applied to a roll compensated steering command to control steering of the vehicle. A gain is applied to a steering command to control steering of the vehicle.

### RELATED APPLICATIONS

The present application claims priority to U.S. Provisional Patent Application No. 60/981,145, filed Oct. 19, 2007, which is incorporated herein by reference.

### FIELD OF THE INVENTION

The present invention pertains to control of vehicles, and in particular, controlling vehicle motion.

### BACKGROUND OF THE INVENTION

A wide range of vehicles and methods are known for transporting human subjects. Typically, such vehicles rely upon static stability and are designed for stability under all foreseen conditions of placement of their ground-contacting members with an underlying surface. For example, a gravity vector acting on the center of gravity of an automobile passes between the points of ground contact of the automobile's wheels and the suspension of the automobile keeps all wheels on the ground at all times making the automobile stable. Although, there are conditions (e.g., increase or decrease in speed, sharp turns and steep slopes) which cause otherwise stable vehicles to become unstable.

A dynamically stabilized vehicle, also known as a balancing vehicle, is a type of vehicle that has a control system that actively maintains the stability of the vehicle while the vehicle is operating. In a vehicle that has only two laterally-disposed wheels, for example, the controller maintains the fore-aft stability of the vehicle by continuously sensing the orientation of the vehicle, determining the corrective action necessary to maintain stability, and commanding the wheel motors to make the corrective action. If the vehicle losses the ability to maintain stability, such as through the failure of a component or a lack of sufficient power, the human subject can experience a sudden loss of balance.

For vehicles that maintain a stable footprint, coupling between steering control and control of the forward motion of the vehicles is less of a concern. Under typical road conditions, stability is maintained by virtue of the wheels being in contact with the ground throughout the course of a turn and while accelerating and decelerating. In a balancing vehicle with two laterally disposed wheels, however, any torque applied to one or more wheels affects the stability of the vehicle.

### SUMMARY OF THE INVENTION

The invention, in one aspect, features a method for controlling a steering command of a transporter having at least one ground-contacting element. The method involves determining an initialization roll deadband value based on initialization of an inertial state estimator of the transporter. The method also involves determining a velocity-based roll deadband value based on a velocity of the at least one ground-contacting element. The method also involves determining a total deadband value based on the initialization roll deadband value and the velocity-based roll deadband value. The method also involves determining a roll compensated steering command signal based on the total deadband value.

In some embodiments, the method involves outputting the roll compensated steering command signal to a propulsion system of the transporter to control steering of the transporter. In some embodiments, the method involves determining a steering roll value based on a roll angle of the transporter and the total deadband value. In some embodiments, determining the steering roll value involves determining the difference between the total deadband value and the roll angle of the transporter if the roll angle of the transporter is greater than or equal to the total deadband value. In some embodiments, determining the steering roll value involves determining the sum of the total deadband value and the roll angle of the transporter if the roll angle of the transporter is less than the total deadband value.

In some embodiments, determining a roll compensated steering command signal involves combining a steering command of the transporter and the steering roll value. In some embodiments, the initialization roll deadband value is set to approximately three degrees in roll when the inertial state estimator of the transporter has not been initialized. In some embodiments, the initialization roll deadband value is set to approximately zero degrees in roll when the inertial state estimator of the transporter has been initialized.

In some embodiments, determining the velocity-based roll deadband value involves setting the velocity-based roll deadband value substantially equal to a zero degrees in roll when the position of a user input device relative to a neutral position is outside a predetermined range of displacement values and increasing or decreasing the velocity-based roll deadband value to a predetermined maximum value when the position of the user input device relative to the neutral position is inside the predetermined range of displacement values.

In some embodiments, the increasing or decreasing of the velocity-based roll deadband value is increased or decreased linearly, quadratically, logarithmically, exponentially or any combination thereof.

The invention, in another aspect, features a controller for steering a transporter having at least one ground-contacting element. The controller includes a roll deadband compensation module having an output that is an initialization roll deadband value, the initialization roll deadband value is determined based initialization of an inertial state estimator of the transporter. The controller also includes a velocity-based roll deadband module having an input of a velocity of the at least one ground-contacting element and an output of a velocity-based roll deadband value, the velocity-based roll deadband value is determined based on the velocity of the at least one ground-contacting element. The controller also includes a total deadband module having inputs of the velocity-based roll deadband value and the initialization roll deadband value and an output of the total deadband value, the output is determined based on the velocity-based roll deadband value and the initialization roll deadband value. The controller also includes a roll compensated steering module having input of a total deadband value and an output of a roll compensated steering command signal, the output is determined based on the total deadband value.

In some embodiments, the controller includes a propulsion system having an input that receives the roll compensated steering command signal to control steering of the transporter.

In some embodiments, the controller includes a steering roll module having inputs of a roll angle of the transporter and the total deadband value and an output of a steering roll value, the output of a steering roll value is determined based on the roll angle and the total deadband value. In some embodiments, the steering roll module include a summer to sum the roll angle of the transporter and the total deadband value if the roll angle of the transporter is greater than or equal to the total deadband value and a subtractor to difference the roll angle of the transporter and the total deadband value if the roll angle of the transporter is less than the total deadband value.

In some embodiments, the roll compensated steering module includes a summer to sum a steering command of the transporter and the steering roll value. In some embodiments, the initialization roll deadband value is set to approximately three degrees in roll when the inertial state estimator of the transporter has not been initialized. In some embodiments, the initialization roll deadband value is set to approximately zero degrees in roll when the inertial state estimator of the transporter has been initialized.

In some embodiments, determining the velocity-based roll deadband module includes a zero input to set the velocity-based roll deadband value substantially equal to a zero degrees in roll when the position of a user input device relative to a neutral position is outside a predetermined range of displacement values and a function module to increase or decrease the velocity-based roll deadband value to a predetermined maximum value when the position of the user input device relative to the neutral position is inside the predetermined range of displacement values.

In some embodiments, the increase or decrease of the velocity-based roll deadband is increased or decreased linearly, quadratically, logarithmically, exponentially or any combination thereof.

The invention, in another aspect, involves a method for controlling a steering command of a transporter having at least one ground-contacting element. The method also involves determining a step gain value of a transporter, the step gain value is set equal to a step on gain value if a rider is stepping on to the transporter or a step off gain value if the rider is stepping off of the transporter. The method also involves determining a mount state value of the transporter, the mount state value is based on whether the rider has one or two feet on the transporter. The method also involves determining a reduction gain value based on an operation mode value of the transporter, a velocity of the at least one ground-contacting element and the mount state value. The method also involves determining a yaw rate reduction gain, the yaw rate reduction gain is the minimum of the reduction gain value and the step gain value. The method also involves determining a transporter steering command based on the yaw rate reduction gain.

In some embodiments, the operation mode value corresponds to one of a beginner mode. In some embodiments, the step mode value is set equal to the step on gain value if rider detect sensors coupled to the transporter detect when a first foot of the rider is on the transporter and a second foot of the rider is off the transporter.

In some embodiments, the step mode value is set equal to the step off gain value if rider detect sensors coupled to the transporter detect when a first foot of the rider is on the transporter and a second foot of the rider is off the transporter and a steering command signal of the transporter is in a direction towards the first foot of the rider that is on the transporter when the steering command signal approaches a value to cause a platform of the transporter to rotate over the second foot.

In some embodiments, determining the step off gain value involves multiplying a side step off gain value by the difference between a current steering command signal and a side step off angle value and subtracting a zero angle gain value from the resultant of the multiply. In some embodiments, determining the side step off gain value involves determining a side step off angle difference value by taking a difference between the zero angle gain value of the transporter and the current steering command signal and multiplying the side step off angle difference value by a side step angle value divided by the zero angle gain value.

The invention, in another aspect, features a controller for steering a transporter having at least one ground-contacting element. The controller also includes a step mode module to compute a step gain value output, the step gain value output is a step on gain value if a rider is stepping on to the transporter and a step off gain value if the rider is stepping off of the transporter. The controller also includes a reduction gain module to compute a reduction gain value output based on inputs of an operation mode value of the transporter, a velocity of the at least one ground-contacting element and a mount state, the mount state value is based on whether the rider has one or two feet on the transporter. The controller also includes a comparator to determine a yaw rate reduction gain value, the yaw rate reduction gain value is the minimum of the reduction gain value and the step gain value. The controller also includes a steering module that computes a transporter steering command based on the yaw rate reduction gain value.

In some embodiments, the operation mode value corresponds to one of a beginner mode. In some embodiments, the controller includes rider detect sensors coupled to the transporter to detect when a first foot of the rider is on the transporter and a second foot of the rider is off the transporter to determine the step mode value is a step on gain value.

In some embodiments, the controller includes a rider detect sensor to detect when a first foot of the rider is on the transporter and a second foot of the rider is off the transporter and the step mode module to determine that a steering command signal of the transporter is in a direction towards the first foot of the rider that is off the transporter when the steering command signal approaches a value to cause a platform of the transporter to rotate over the second foot to determine the step mode value is a step off gain value.

In some embodiments, the step mode module includes a multiplier to multiply a side step off gain by the difference between a current steering command signal and a side step off angle value and a subtractor to subtract a zero angle gain value from the resultant of the multiplier to compute the step off gain value.

In some embodiments, the controller includes a side step off angle difference module to determining a side step off angle difference value by taking a difference between the zero angle gain value of the transporter and the current steering command signal and a multiplier to multiply the side step off angle difference value by a side step angle value divided by the zero angle gain value to compute the side step off reduction gain scale value.

The invention, in another aspect, features a controller for steering a transporter having at least one ground-contacting element. The controller also includes means for determining an initialization roll deadband value based on if an inertial state estimator of the transporter has been initialized. The controller also includes means for determining a velocity-based roll deadband value based on the velocity of the at least one ground-contacting element. The controller also includes means for determining a total deadband value based on the velocity-based roll deadband value and the initialization roll deadband value. The controller also includes means for determining a steering roll value based on a roll angle of the transporter and the total deadband value. The controller also includes means for determining a roll compensated steering command signal based on the steering roll value.

### BRIEF DESCRIPTION OF THE DRAWINGS

The foregoing features of the invention will be more readily understood by reference to the following detailed description, taken with reference to the accompanying drawings, in which:

FIG. 1 is a schematic illustration of a transporter, as described in detail in U.S. Pat. No. 6,302,230, to which the present invention may be applied.

FIG. 2 is a diagram showing a land-based vehicle and corresponding vehicle frame (V-frame) coordinate axes in the presence of a roll angle along with the Earth frame (E-frame) coordinate axes of the earth.

FIG. 3 is a block diagram showing sensors, power and control, according to an illustrative embodiment of the invention.

FIG. 4 is a block diagram showing the constitutive inputs and outputs of a yaw command in a system architecture to which the present invention may be advantageously applied.

FIG. 5 is a flow diagram illustrating a method for controlling steering of a vehicle, according to an illustrative embodiment of the invention.

FIG. 6 is a block diagram showing controller modules used by a controller to control steering of a vehicle, according to an illustrative embodiment of the invention.

FIG. 7A is a top view of the platform of a transporter with the pressure plate removed, indicating the placement of feet-force pressure sensors, according to an illustrative embodiment of the invention.

FIG. 7B shows two foot plates for detecting placement of rider's left and right foot, according to an illustrative embodiment of the invention.

FIG. 8 is a flow diagram illustrating a method for controlling steering of a vehicle, according to an illustrative embodiment of the invention.

FIG. 9 is a block diagram showing control modules used by a controller to control steering of a vehicle, according to an illustrative embodiment of the invention.

### DETAILED DESCRIPTION OF ILLUSTRATIVE EMBODIMENTS

Embodiments of the present invention are useful in vehicles that utilize controllers to control direction and velocity of the vehicle. Such controllers typically use a command from a user input device and the vehicle's current orientation and current velocity to control the vehicle's ground-contacting elements (e.g., wheels). A rider typically drives the vehicle by moving the user input device to command the direction and velocity of the vehicle that the rider desires. The rider's command can have, for example, a velocity component and a directional component (e.g., yaw angle). The rider can also use the user input device to indicate an operation mode (e.g., a rider experience level).

Driving a vehicle along rough terrain (e.g., bumps) at low speeds can cause the rider to experience a disturbance. The disturbance can cause the rider to unintentionally move the user input device, thus commanding an undesired change in direction and velocity of the vehicle. A controller can derive terrain information based on the vehicle's orientation and velocity to determine if the vehicle is driving over rough terrain. In the event that the vehicle is driving over rough terrain, the controller can reduce the effect of the rider's command inputs to the user input device. Sometimes, driving the vehicle along a sloped surface can incorrectly cause the vehicle's orientation and velocity to indicate that the vehicle is driving along rough terrain. In this case, the controller can ignore the terrain information and neglect to reduce the effect of the rider's command inputs to the user input device.

Inexperience of a rider can cause a rider to unintentionally move the user input device causing a change in direction and velocity of the vehicle. Mounting and dismounting the vehicle can also cause a rider to unintentionally move the user input device. For example, during mounting the vehicle the rider might hold and pull the user input device causing the user input device to move, thus commanding an unintended change of direction and velocity of the vehicle. A controller implementing various embodiments of the invention can lessen the effect of the rider's unintended command on vehicle operation. In some embodiments, the experience of the rider and the mount state of the vehicle is used to modify the controller's operation.

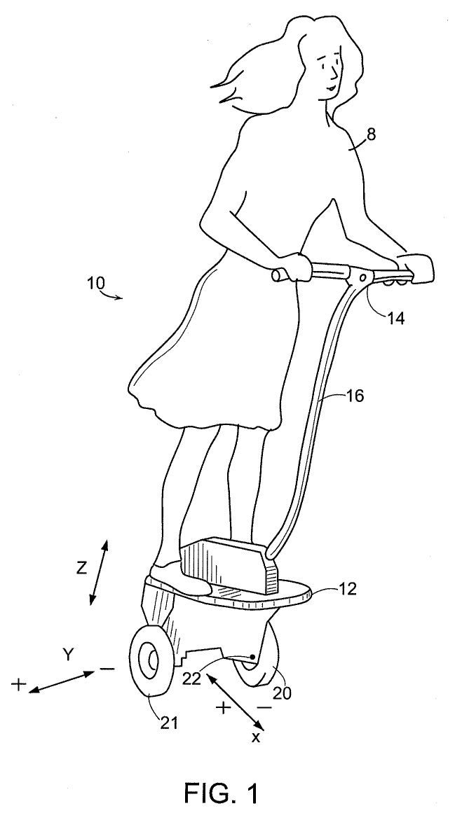

Embodiments of the present invention are useful with various types of vehicles, for example, statically stable vehicles and dynamically stabilized vehicles (e.g., dynamically stabilized balancing transporters). FIG. 1 shows a balancing personal transporter, designated generally by numeral 10 as an example of a vehicle to which the present invention may be applied. A subject 8 stands on a support platform 12 and holds a grip 14 on a handle 16 attached to the platform 12. A control loop may be provided so that leaning of the subject 8 results in the application of torque to wheel 20 and/or wheel 21 about axle 22 by means of two motor drives (not shown) located in platform 12. Transporter 10, however, is statically unstable. Absent operation of a controller to maintain dynamic stability, transporter 10 will no longer be able to operate in its typical operating orientation. “Stability” as used herein, refers to the mechanical condition of an operating position with respect to which the system will naturally return if the system is perturbed away from the operating position in any respect.

The dynamic behavior of a vehicle may be described through reference to a coordinate system. Two such coordinate systems are used in describing the motion of a vehicle about irregular surfaces: the Earth reference frame, “E-frame”, and the vehicle reference frame “V-frame”.

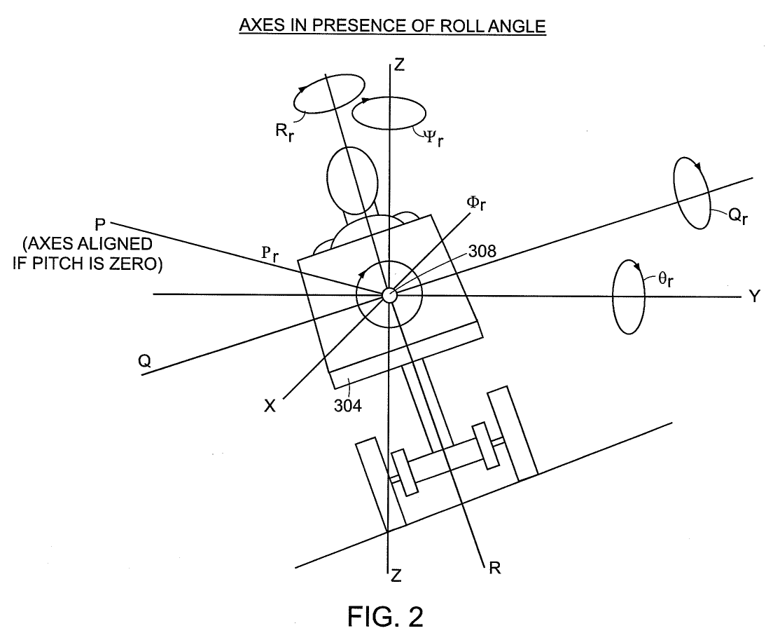

The E-frame defines the vertical axis, Z, to be co-linear to the direction of gravity and passing through a position of the center of gravity 308 of an occupied vehicle 304 as shown in FIG. 2. The position of the origin of the E-Frame axes about the position of the center of gravity 308 is an arbitrary choice and it should be understood by those skilled in the art that the origin may be positioned about other points on the vehicle 304. The E-frame defines the roll axis, X, as a component in the direction of travel perpendicular to the vertical axis and passing through the position of the center of gravity 308 of the occupied vehicle 304, and the E-frame defines the pitch axis, Y, to be orthogonal to both the Z and X axes and passing through the position of the center of gravity 308 of the occupied vehicle 304. Rotation around the Z axis is described by the angle Ψ, also known as the yaw angle. Rotation around the X axis is described by the angle Φ, also known as the roll angle. Rotation around the Y axis is described by the angle θ, also known as the pitch angle.

The axes associated with the V-frame have an origin located at the position of the center of gravity 308 of the vehicle 304. In other embodiments, the origin of the axes may be situated at another point on the vehicle 304. The axes are fixed with respect to the vehicle 304. The relative vertical axis, R, is a specified, vehicle-fixed, substantially vertical axis and may be defined by a line passing through the position of the center of gravity 308 of the vehicle 304 and the support/backrest/head of a rider of the vehicle 304. The relative horizontal axis, P, is perpendicular to the relative vertical axis and has a component parallel to the direction of movement of the vehicle 304. The third axis, Q, is orthogonal to both R and P. The relative orientation of the R, P, Q frame varies with respect to the Z, X, Y frame as the vehicle 304 tilts. As shown in FIG. 2, the P and X axes are co-linear, however, R and Z, and Q and Y are not co-linear, showing that the vehicle is “rolling” and thus there is a non-zero roll angle, Φ.

The equations below present the rate transformations between the E-frame and V-frame under a small angle approximation for the respective rotation rates, denoted by the subscript r. These transformations will be referred to as small angle Euler transforms (SAETs) and inverse SAETs respectively.

$$\begin{matrix}[ \begin{matrix}{Φ}_{r} \\ {θ}_{r} \\ {Ψ}_{r}\end{matrix} ] = [ \begin{matrix}1 & θ Φ & - θ \\ 0 & 1 & Φ \\ 0 & - Φ & 1\end{matrix} ] [ \begin{matrix}{P}_{r} \\ {Q}_{r} \\ {R}_{r}\end{matrix} ] & EQN . 1 \\ [ \begin{matrix}{P}_{r} \\ {Q}_{r} \\ {R}_{r}\end{matrix} ] = [ \begin{matrix}1 & 0 & θ \\ 0 & 1 & - Φ \\ 0 & Φ & 1\end{matrix} ] [ \begin{matrix}{Φ}_{r} \\ {θ}_{r} \\ {Ψ}_{r}\end{matrix} ] & EQN . 2\end{matrix}$$

Inertial sensors, (e.g., angular rate sensors or rate gyroscopes) are used to provide pitch state, roll state and yaw state information to the vehicle 304. The inertial sensors measure the rate of change of the orientation of the vehicle 304 about the V-frame and produce a signal that is representative of the rate of change of the pitch, roll, and yaw angles of the vehicle 304. The inertial sensors need to be adjusted regularly due to sensor drift. Thus, tilt sensors are incorporated into the system for providing a stable angular value from which bias errors of the inertial sensors may be compensated. More than one tilt sensor may be used to provide redundancy in the event of one tilt sensor failing. In one embodiment of the invention, the inertial sensors are gyros. In other embodiments, however, the rate sensor may be any other inertial measurement device (e.g., single or multiple axis accelerometers or geophones).

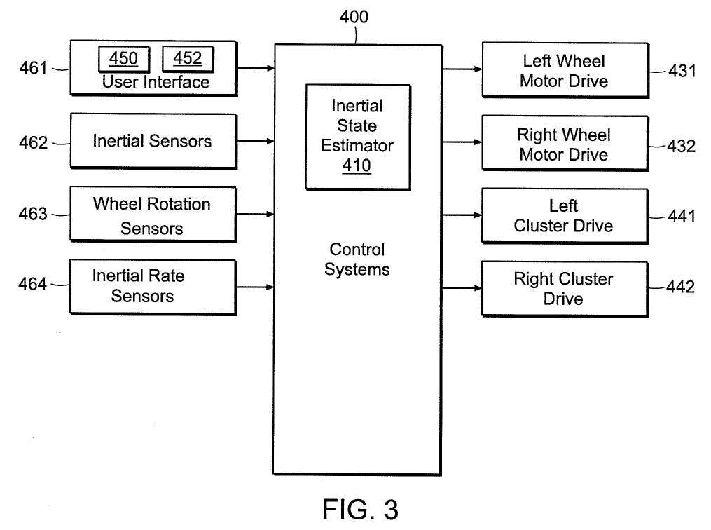

FIG. 3 is a block diagram of a control system 400 for controlling a vehicle, according to an illustrative embodiment of the invention. In this embodiment of the invention, the control system 400 is used to control the motor drives and actuators of a vehicle, for example, the balancing transporter 10 of FIG. 1. Motor drives 431 and 432 control the left 20 and right 21 wheels of the transporter 10, respectively. The control system 400 has data inputs including user interface 461, inertial sensors 462 for sensing pitch, roll and yaw angles of the vehicle, wheel rotation sensors 463, and inertial rate sensors 464 for sensing the rate of change of the pitch, roll and yaw angles of the vehicle 304. The control system 400 has an inertial state estimator module 410 that derives pitch rate and pitch, roll rate and roll, and yaw rate and yaw through the use of the inertial rate sensors 464 once the inertial rate sensors 464 have been initialized. The user interface 461 includes two steering sensors, 450 and 452. The steering sensor 450 and 452 are used to detect user input (e.g., change of position of a user input device) that is input by a rider through the user interface 461. In one embodiment, a roll sensor may be used to sense roll of the vehicle. In one embodiment, a roll rate sensor may be used to sense roll rate of the vehicle. In one embodiment, a pitch state estimator is used to derive pitch and pitch rate, roll and roll rate, and yaw and yaw rate. In other embodiments, the control system 400 may have more than two wheel motor drives for, for example, a vehicle with more than two wheels.

One mechanism for providing user input for a yaw control system of a personal transporter is described in detail in U.S. Pat. No. 6,789,640. As described therein, a user mounted on a transporter may provide yaw control input to a yaw controller by rotating a yaw grip assembly.

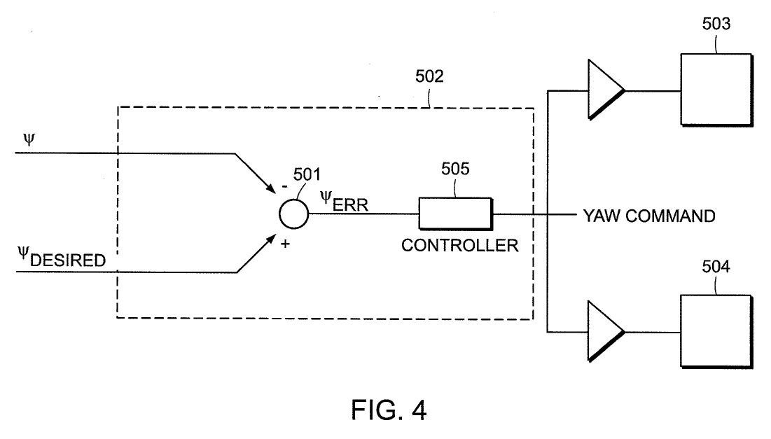

FIG. 4 is a block diagram showing the constitutive inputs and outputs of a yaw command in a system architecture to which the present invention may be advantageously applied. FIG. 4 depicts the differencing, in summer 501, of the current yaw value ψ with respect to the desired yaw value ψ_{desired} to obtain the current yaw error ψₑᵣᵣ as part of yaw controller 502. Desired yaw value ψ_{desired} is obtained from a user input, various embodiments of which are described, therein. The current value ψ of yaw is derived from various state estimates, such as the differential wheel velocities, inertial sensing, etc. Derivation of the yaw command from the yaw error is provided by motor controller 505 according to various processing algorithms described, for example, in U.S. Pat. No. 6,288,505, and applied to left and right motors 503 and 504, respectively.

Driving a vehicle along rough terrain (e.g., bumps) at low speeds can cause a rider to experience a disturbance. The disturbance can cause the rider to unintentionally move a user input device, thus commanding an undesired change in direction and velocity of the vehicle. A controller can derive terrain information based on the vehicle's current orientation and current velocity to determine if the vehicle is driving over rough terrain. In the event that the vehicle is driving over rough terrain, the controller can reduce the effect that the rider's command inputs to the user input device have on vehicle operation by compensating for a directional component of the rider's command (e.g., steering command) based on the vehicle's current roll angle. The vehicle's current roll angle varies with rough terrain. Sometimes, driving the vehicle along a sloped surface at low speeds can incorrectly cause the vehicle controller to interpret the vehicle's current orientation and current velocity as being a result of travelling over rough terrain. In this case, the controller can apply a deadband to the steering command that has been roll compensated to reduce the effect of the vehicle's roll angle on the directional component of the rider's command inputs to the user input device.

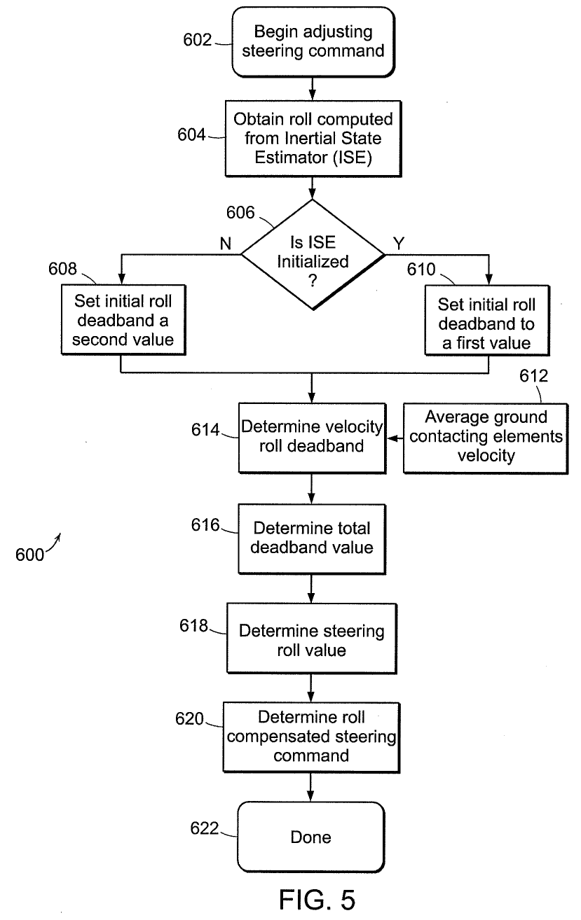

FIG. 5 is flow diagram 600 illustrating a method for controlling steering of a vehicle, according to an illustrative embodiment of the invention. The method includes beginning a process of adjusting a steering command of a vehicle (Step 602). Step 602 may be initiated by, for example, a vehicle controller that senses when the vehicle is driving along the sloped surface.

The method also includes obtaining a roll angle of the vehicle from an inertial state estimator module (Step 604), for example, as described above in FIG. 3. The inertial state estimator module obtains measurements from one or more sensors (e.g., inertial sensors 462 of FIG. 3) to determine the roll angle. There is a time delay between starting a vehicle and the point in time when the vehicle's sensors are initialized. The time delay is due to the time it takes sensors to initialize once powered. The inertial state estimator module can output an erroneous roll angle before the sensors are initialized. Therefore, setting an initialization roll deadband value before the sensors have been initialized can reduce the effect of roll compensation on the rider's command inputs to the user input device. Once the inertial state estimator module has been initialized (Step 606), an initialization roll deadband value is set to a first value in roll that does not reduce the effect of roll compensation on the rider's command inputs to the user input device (Step 610). However, while the inertial state estimator module has not been initialized (Step 606), the initialization roll deadband value is set to a second value in roll that does reduce the effect of the roll compensation on the rider's command inputs to the user input device (Step 608). In some embodiments, the first value is zero degrees in roll. In some embodiments, the second value ranges from zero to three degrees in roll.

The method also includes determining a velocity-based roll deadband value (DBᵥₑₗ) (Step 614) based on a velocity of the ground contacting elements of the vehicle (Step 612). In this embodiment, the velocity-based roll deadband value is determined based on the following computation:

$$D {B}_{vel} = ( - 1 ) \frac{D B {W}_{Max}}{D B {V}_{Max}} \cdot V + D B {W}_{Max} \qquad EQN . 3$$

where, DBW_{Max} is a maximum deadband width. The DBW_{Max} is a predefined value that is equal to a distance a user input device is displaced relative to a neutral position. The controller uses the velocity-based roll deadband in determining the steering command when displacement of the user input device is within the range of DBW_{Max}. In this case, the controller uses the velocity-based roll deadband because the user input device is displaced within a distance, between the neutral position and DBW_{Max}, that is caused by the sloped surface. Once the user input device is displaced a distance outside of the range set by DBW_{Max}, even if the vehicle is travelling along a sloped surface, the controller does not use the velocity-based roll deadband. In this case, the controller does not use the velocity-based roll deadband because the displacement is a sufficient distance from the neutral position that it is interpreted that the displacement was intended by the rider and not due to the sloped surface.

For example, if the user input device is a handle (e.g., the handle 16 of FIG. 1) and the handle moves along the y-axis direction (e.g., y-axis of FIG. 1) where zero degrees is the neutral position and DBW_{Max} is five degrees, when the rider moves the user input device an angle that is within plus or minus zero to five degrees from the neutral position (zero degrees) then the velocity-based roll deadband value is used by the controller. When the rider moves the user input device an angle that is greater than plus or minus five degrees the velocity-based roll deadband is not used by the controller.

DBV_{Max} is a vehicle velocity threshold for which the vehicle's velocity must be lower than or equal too for the controller to apply the velocity-based roll deadband. Once the vehicle's velocity is greater than DBV_{Max}, the controller will not apply the velocity-based roll deadband because driving the vehicle along a sloped surface at speeds above DBV_{Max} does not cause the vehicle controller to interpret the vehicle's current orientation and current velocity as being a result of travelling over rough terrain. V is average velocity of the vehicle. In some embodiments, the velocity-based roll deadband value is computed using linear, quadratic, logarithmic, exponential functions (or any combination thereof) of DBW_{Max}, DBV_{Max} and V.

The method also includes determining a total deadband value (DBₜₒₜ) (Step 616). In this embodiment, the total deadband value (DBₜₒₜ) is determined by summing the initialization roll deadband value (DBᵢₙₜ) and the velocity-based roll deadband value (DBᵥₑₗ).

The method also includes determining a steering roll value (Sᵣₒₗₗ) based on the roll angle (Φ) of the vehicle and the total deadband value (DBₜₒₜ) (Step 618). In this embodiment, the steering roll value is determined by the following computation:

Sₛᵣₒₗₗ=Φ+DBₜₒₜ; if Φ<=DBₜₒₜ EQN. 4

Sₛᵣₒₗₗ=Φ−DBₜₒₜ; if Φ>DBₜₒₜ EQN. 5

The method also includes determining the roll compensated steering command (Sᵣₒₗₗ) signal based on the steering roll value (Step 620). In this embodiment, the roll compensated steering command is determined by the following computation:

Sᵣₒₗₗ=S+Sₛᵣₒₗₗ EQN. 6

where, S is a steering command input by the rider (e.g., via a user input device). The roll compensated steering command (Sᵣₒₗₗ) can be, for example, a yaw command. The steering command (S) can be measured by a sensor coupled to the user input device (e.g., the handle 16 of FIG. 1). The steering command (S) can be the average of two sensors coupled to the user input device and configured to measure the same user input device steering command (S) to provide sensor redundancy in the case of a single sensor failure. The method also includes completing the adjustment of the steering command (Step 622). Step 622 may include outputting the roll compensated steering command (Sᵣₒₗₗ). In one embodiment, the roll compensated steering command (Sᵣₒₗₗ) is received by an input of a propulsion system to control steering of the vehicle.

In some embodiments, the steering roll value is limited to a maximum displacement angle from a neutral position for the user input device such that input from displacing the user input device dominates the roll compensated steering command. In one embodiment, the steering roll value is a value within a range of, for example, plus or minus twenty five degrees in roll.

In some embodiments, the total deadband value (DBₜₒₜ) is transitioned over time into the steering roll value (Sₛᵣₒₗₗ) to avoid an abrupt transition in a steering command signal provided to the vehicle. For example, an intermediate deadband value (DBᵢₙₜ) can be used above in EQN. 4 and EQN. 5 in place of the total deadband value (DBₜₒₜ). A deadband transition rate defines a number of degrees in roll per second that the roll compensated steering command (Sᵣₒₗₗ) can be changed by the total deadband value (DBₜₒₜ). In one embodiment, the deadband transition rate is equal to two degrees in roll per second, and the total deadband value equal to six degrees in roll. Every second the intermediate deadband value (DBᵢₙₜ) is increased or decreased two degrees, both the steering roll value (Sₛᵣₒₗₗ) and the roll compensated steering command (Sᵣₒₗₗ) are updated every second, until the intermediate deadband value (DBᵢₙₜ) reaches the total deadband value (DBₜₒₜ) of six degrees.

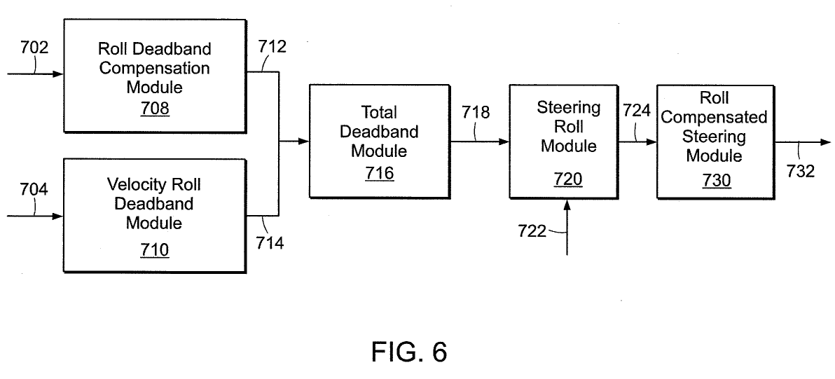

FIG. 6 is a block diagram showing controller modules used by a controller (not shown) to control steering of a vehicle, according to an illustrative embodiment of the invention. A roll deadband compensation module 708 receives an initialization input signal 702 (e.g., from an inertial state estimator module (not shown)). The roll deadband compensation module 708 outputs an initial deadband value output 712 based on whether an inertial state of estimate of the vehicle has been initialized. In some embodiments, the roll deadband compensation module implements steps 606, 608 and 610, as described in FIG. 5.

A velocity-based roll deadband module 710 receives a velocity input signal 704. The velocity-based roll deadband module 710 outputs a velocity-based roll deadband value output 714 based on a velocity of at least one ground contacting member of the vehicle. In some embodiments, the velocity-based roll deadband module 710 implements steps 612 and 614, as described above in FIG. 5.

A total deadband module 716 receives the initial deadband value output signal 712 and the velocity-based roll deadband output signal 714. The total deadband module 716 outputs a total deadband value output 718 based on the initial deadband value output 712 and the velocity-based roll deadband value output 714. In some embodiments, the total deadband module 716 implements step 616, as described above in FIG. 5.

A steering roll module 720 receives the vehicle roll angle input signal 722 and the total deadband value output 718. The steering roll module 720 outputs a steering roll value output 724 based on the vehicle roll angle input signal 722 and the total deadband value output 718. In some embodiments, the steering roll module 720 implements step 618, as described above in FIG. 5.

A roll compensation steering module 730 receives the steering roll value output 718. The roll compensation steering module 730 outputs a roll compensated steering command output 732 based on the steering roll value output 718. In some embodiments, the roll compensation steering module 730 implements step 620, as described above in FIG. 5. The controller 700 of FIG. 6 can implement the method steps implemented in FIG. 5 or can implement other methods for controlling the steering of a vehicle. In some embodiments, the controller 700 has different parameters and parameter values for the method steps of FIG. 5. By way of example, in one embodiment, controller 700 implements the method steps of FIG. 5, but the initialization roll deadband value has a range of zero to four degrees when the inertial state estimator has not been initialized.

Inexperience of a rider can cause a rider to unintentionally move the user input device causing a change in direction and velocity of the vehicle. Mounting and dismounting the vehicle can also cause a rider to unintentionally move the user input device. For example, during mounting the vehicle the rider might hold and pull the user input device causing the user input device to move, thus commanding a unintended change of direction and velocity of the vehicle. A controller implementing various embodiments of the invention can lessen the effect in vehicle operation of the rider's unintended command. In some embodiments, the experience of the rider and the mount state of the vehicle is used to modify the controller's operation.

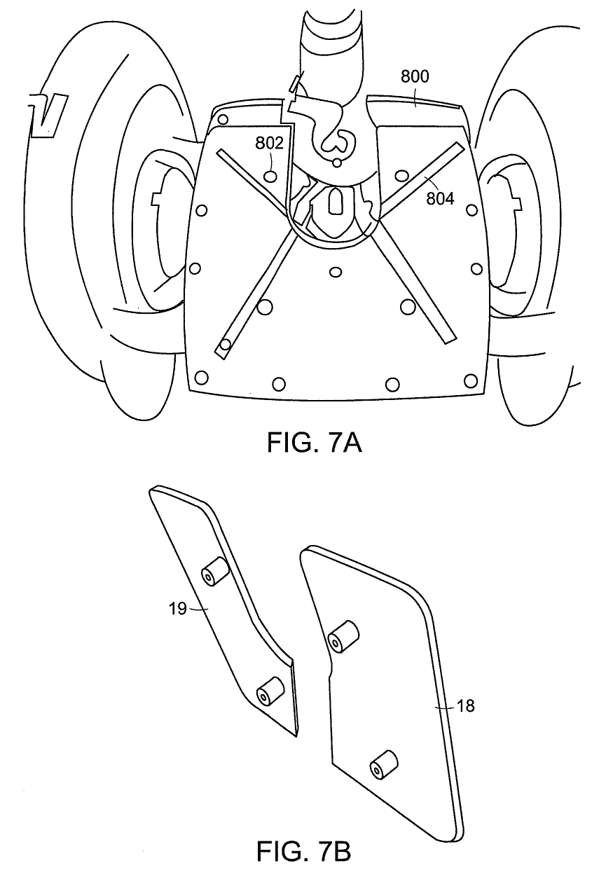

The mount state of the vehicle can be sensed by sensors attached to a vehicle. For a transporter (e.g., transporter 10 of FIG. 1), the rider's mount state can be sensed by sensing the weight of a rider's left and right foot. FIGS. 7A and 7B are illustrations of a platform 800 of a transporter with pressure sensing plates 18 and 19 (for example, platform 12 of FIG. 1). FIG. 7A is a top view of the platform 800 of the transporter with the pressure plates 18 and 19 removed, illustrating the placement of the feet-force pressure sensors 802 and 804, according to an illustrative embodiment of the invention. FIG. 7B is an isometric view of the two plates 18 and 19 for detecting placement of the user's left and right foot.

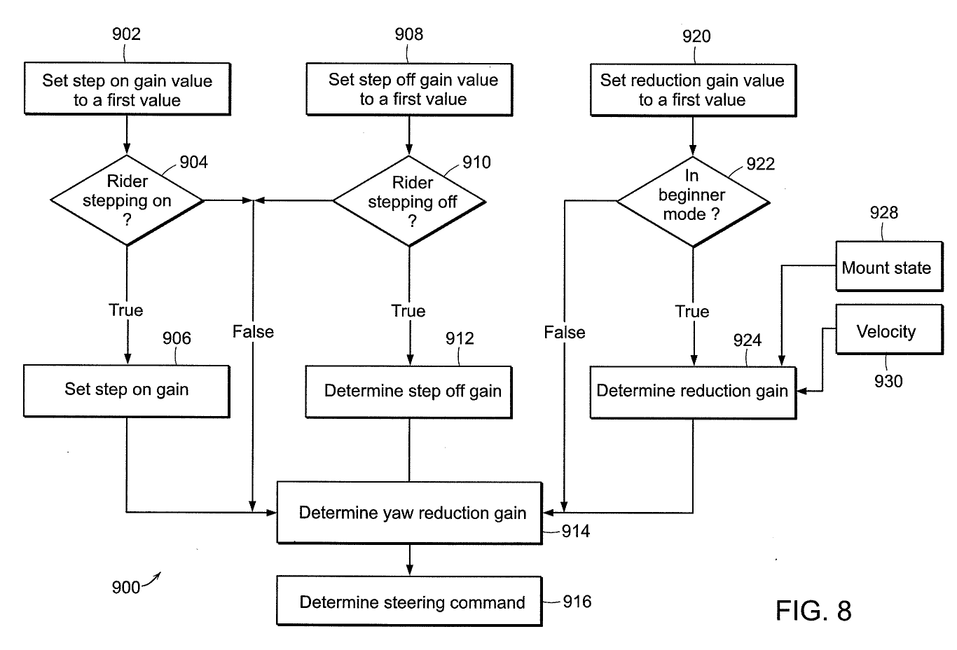

FIG. 8 is a flow diagram 900 illustrating a method for controlling steering of a vehicle, according to an illustrative embodiment of the invention. In one embodiment, the vehicle is the transporter 10 of FIG. 1. The method includes setting a step on gain value (Step 902), setting a step off gain value (Step 908), and setting a reduction gain value (Step 920). The step on gain value, step off gain value and reduction gain value are each set to a first value. In some embodiments, the first value ensures a gain value is determined in the event that a rider is not stepping on or stepping off the transporter and the transporter is not in a beginning mode operation. In one embodiment, the step on gain value is set to a first value of 1.0, the step off gain value is set to first value of 1.0 and the reduction gain value is set to a first value of 1.0.

The method also includes determining if a rider is stepping on the transporter (Step 904). In one embodiment, the step on gain value is set to a value of 0.5 if a rider is stepping on the transporter (Step 906). In one embodiment, a rider is stepping on the transporter when one foot of the rider is on the transporter and the other foot of the rider is off the transporter. A rider is also stepping on the transporter when both feet of the rider are off the transporter and a rider's command (e.g., movement of a vehicle input, for example, movement of handle 16 of FIG. 1 along the X-axis direction of the vehicle) has a velocity component that is greater than a predefined velocity threshold. In some embodiments, the velocity threshold is three miles per hour. In some embodiments, the step on gain value is a value that ranges from 0.0 to 1.0. In some embodiments, the specific value selected for the step on gain (or other gains in the system) is based on the experience of the rider.

The method also includes determining if a rider is stepping off the transporter (Step 910). The step off gain value (K_{off}) is determined if a rider is stepping off the transporter (Step 912). In one embodiment, a rider is stepping off the transporter when one foot of the rider is on the transporter, the other foot of the rider is off the transporter and a steering command input by the rider is in the same direction as the foot that is on the transporter. In one embodiment, the step off gain value is determined by the following computation:

K_{off}=K_{zero}−K_{side}|S_{com}−S_{off}| EQN. 7

where K_{zero} is a zero gain angle, K_{side} is side step off gain value, S_{com} is a steering command signal (e.g., the rider's input command to the vehicle via a user input device) and S_{off} is a side step off angle value. In one embodiment, the zero gain angle (K_{zero}) is the angle of the input device with respect to a neutral position. The step off gain value is zero when the angle of the input device is in the neutral position. The side step off angle value (S_{off}) is the current angle of the input device with respect to the neutral position. In one embodiment, the side step of gain value (K_{side}) is determined based on the following computation:

Kₛₜₑₚ=K_{off}/K_{zero}(K_{zero}−S_{com}) EQN. 8

The method also includes determining if an operation mode of the transporter is a beginning mode (Step 922). A reduction gain value is determined if the operation mode of the transporter is a beginning mode (Step 924). The reduction gain value (K_{red}) is based on whether the transporter is fully or partially mounted (Step 928) and the velocity of the ground contacting members (Step 930). In one embodiment, the reduction gain value (K_{red}) is determined based on the following computation:

K_{red}=Mₘₒᵤₙₜ*V+Kₘᵢₙ EQN. 9

where Mₘₒᵤₙₜ is a slope value that depends on whether the transporter is fully (e.g., two feet of the rider are on the transporter) or partially (e.g., one foot of the rider is on the transporter) mounted, V is the velocity of the ground contacting members and Kₘᵢₙ is a minimum gain based on whether the transporter is fully or partially mounted. In one embodiment, the slope value (Mₘₒᵤₙₜ) is 0.2125 for a partially mounted transporter and 0.15 for a fully mounted transporter. In one embodiment, the minimum gain (Kₘᵢₙ) is 0.15 for a partially mounted transporter and 0.55 for a fully mounted transporter.

The method also includes determining a yaw rate reduction gain (Step 914). The yaw rate reduction gain is equal to the minimum of the step on gain value, the step off gain value and the reduction gain value. The method also includes determining a steering command (Step 916). In one embodiment, the steering command is computed by multiplying the rider input command by the yaw rate reduction gain.

In some embodiments, the effect of the yaw rate reduction gain is slowly transitioned into the steering command to avoid an abrupt transition in the steering command signal provided to the transporter. For example, an intermediate yaw rate reduction gain value can be used to determine the steering command and in place of the yaw rate reduction gain value. A yaw rate reduction gain transition rate defines a number of gain per second that the steering command can be changed by the yaw rate reduction gain value. In one embodiment, the yaw rate reduction gain transition rate is equal to a change of 0.2 per second, and the yaw rate reduction gain value is 0.6. Every second the intermediate yaw rate reduction gain value is increased or decreased 0.2 and the steering command is updated, until the intermediate yaw rate reduction gain value reaches the yaw rate reduction gain value of 0.6.

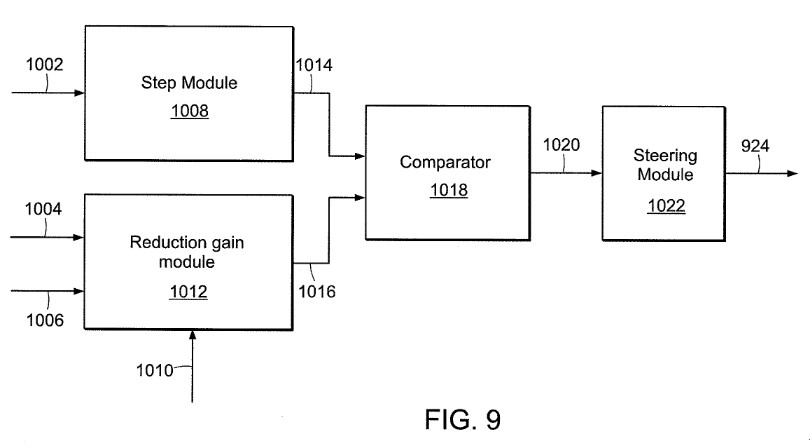

FIG. 9 is a block diagram showing control modules used by a controller (not shown) to control steering of a vehicle, according to an illustrative embodiment of the invention. In one embodiment, the vehicle is transporter 10 of FIG. 1. A step mode module 1008 receives a step mode input 1002. The step mode module 1008 outputs a step gain value output 1014 based on whether a rider is stepping on or off of the transporter. In one embodiment, the step gain value output 1014 is either a step on gain value or a step off gain value. In some embodiments, the step mode module 1008 can implement steps 902, 904, 906, 908, 910 and 912, as described in FIG. 8.

A reduction gain module 1012 receives a velocity input signal 1004, a mount state input signal 1006 and an operation mode input signal 1010. The reduction gain module 1012 outputs a reduction gain value output 1016 based on a velocity of the ground contacting elements, whether the transporter is fully or partially mounted and whether an operation mode of the transporter is a beginner mode. In some embodiments, the reduction gain module 1012 implements steps 920, 922, 924, 928, and 930, as described in FIG. 8.

A comparator 1018 receives the step gain value output signal 1014 and the reduction gain value output signal 1016. The comparator 1018 outputs a yaw rate reduction gain value output 1020 based on the step gain value output signal 1014 and the reduction gain value output signal 1016. In some embodiments, the comparator 1018 implements step 914, as described in FIG. 8.

A steering module 1022 receives the yaw rate reduction gain value output signal 1020. The steering module 1022 outputs a steering command output 1024 based on the yaw rate reduction gain value output 1020. In some embodiments, the steering module 1022 implements step 918, as described in FIG. 8. In some embodiments, the controller 1000 has different parameters and parameter values for the method steps of FIG. 8. By way of example, in one embodiment, controller 1000 implements the method steps of FIG. 8, but the step on gain value has a range of 0.0 to 0.5 when the rider is stepping on the transporter.

In various embodiments, the disclosed methods may be implemented as a computer program product for use with a computer system. Such implementations may include a series of computer instructions fixed either on a tangible medium, such as a computer readable medium (e.g., a diskette, CD-ROM, ROM, or fixed disk) or transmittable to a computer system, via a modem or other interface device, such as a communications adapter connected to a network over a medium. The medium may be either a tangible medium (e.g., optical or analog communications lines) or a medium implemented with wireless techniques (e.g., microwave, infrared or other transmission techniques). The series of computer instructions embodies all or part of the functionality previously described herein with respect to the system. Those skilled in the art should appreciate that such computer instructions can be written in a number of programming languages for use with many computer architectures or operating systems.

Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable medium with accompanying printed or electronic documentation (e.g., shrink wrapped software), preloaded with a computer system (e.g., on system ROM or fixed disk), or distributed from a server or electronic bulletin board over the network (e.g., the Internet or World Wide Web). Of course, some embodiments of the invention may be implemented as a combination of both software (e.g., a computer program product) and hardware. Still other embodiments of the invention are implemented as entirely hardware, or entirely software (e.g., a computer program product).

The described embodiments of the invention are intended to be merely exemplary and numerous variations and modifications will be apparent to those skilled in the art. All such variations and modifications are intended to be within the scope of the present invention as defined in any appended claims.

1. A method for controlling a steering command of a transporter having at least one ground-contacting element, the method comprising:
determining an initialization roll deadband value based on initialization of an inertial state estimator of the transporter;
determining a velocity-based roll deadband value based on a velocity of the at least one ground-contacting element;
determining a total deadband value based on the initialization roll deadband value and the velocity-based roll deadband value; and
determining a roll compensated steering command signal based on the total deadband value.

2. The method of claim 1, comprising outputting the roll compensated steering command signal to a propulsion system of the transporter to control steering of the transporter.

3. The method of claim 1, comprising determining a steering roll value based on a roll angle of the transporter and the total deadband value.

4. The method of claim 3, wherein determining the steering roll value comprises:
determining the difference between the total deadband value and the roll angle of the transporter if the roll angle of the transporter is greater than or equal to the total deadband value.

5. The method of claim 4, wherein determining the steering roll value comprises:
determining the sum of the total deadband value and the roll angle of the transporter if the roll angle of the transporter is less than the total deadband value.

6. The method of claim 5, wherein determining a roll compensated steering command signal comprises combining a steering command of the transporter and the steering roll value.

7. The method of claim 1, wherein the initialization roll deadband value is set to approximately three degrees in roll when the inertial state estimator of the transporter has not been initialized.

8. The method of claim 1, wherein the initialization roll deadband is set to approximately zero degrees in roll when the inertial state estimator of the transporter has been initialized.

9. The method of claim 1, wherein determining the velocity-based roll deadband value comprises:
setting the velocity-based roll deadband value substantially equal to a zero degrees in roll when the position of a user input device relative to a neutral position is outside a predetermined range of displacement values; and
increasing or decreasing the velocity-based roll deadband value to a predetermined maximum value when the position of the user input device relative to the neutral position is inside the predetermined range of displacement values.

10. The method of claim 9, wherein the increasing or decreasing of the velocity-based roll deadband value is increased or decreased linearly, quadratically, logarithmically, exponentially or any combination thereof.

11. A controller for steering a transporter having at least one ground-contacting element, the controller comprising:
a roll deadband compensation module having an output that is an initialization roll deadband value, the initialization roll deadband value is determined based on initialization of an inertial state estimator of the transporter;
a velocity-based roll deadband module having an input of a velocity of the at least one ground-contacting element and an output of a velocity-based roll deadband value, the velocity-based roll deadband value is determined based on the velocity of the at least one ground-contacting element; and
a total deadband module having inputs of the velocity-based roll deadband value and the initialization roll deadband value and an output of the total deadband value, the output is determined based on the velocity-based roll deadband value and the initialization roll deadband value; and
a roll compensated steering module having input of a total deadband value and an output of a roll compensated steering command signal, the output is determined based on the total deadband value.

12. The controller of claim 11, comprising a propulsion system having an input that receives the roll compensated steering command signal to control steering of the transporter.

13. The controller of claim 11, comprising a steering roll module having inputs of a roll angle of the transporter and the total deadband value and an output of a steering roll value, the output of a steering roll value is determined based on the roll angle and total deadband value.

14. The controller of claim 13, wherein the steering roll module comprises:
a summer to sum the roll angle of the transporter and the total deadband value if the roll angle of the transporter is greater than or equal to the total deadband value; and
a subtractor to difference the roll angle of the transporter and the total deadband value if the roll angle of the transporter is less than the total deadband value.

15. The controller of claim 14, wherein the roll compensated steering module comprises a summer to sum a steering command of the transporter and the steering roll value.

16. The controller of claim 11, wherein the initialization roll deadband value is set to approximately three degrees in roll when the inertial state estimator of the transporter has not been initialized.

17. The controller of claim 11, wherein the initialization roll deadband is set to approximately zero degrees in roll when the inertial state estimator of the transporter has been initialized.

18. The controller of claim 11, wherein determining the velocity-based roll deadband module comprises:
a zero input to set the velocity-based roll deadband value substantially equal to a zero degrees in roll when the position of a user input device relative to a neutral position is outside a predetermined range of displacement values; and
a function module to increase or decrease the velocity-based roll deadband value to a predetermined maximum value when the position of the user input device relative to the neutral position is inside the predetermined range of displacement values.

19. The controller of claim 18, wherein the increase or decrease of the velocity-based roll deadband is increased or decreased linearly, quadratically, logarithmically, exponentially or any combination thereof.

20. A method for controlling a steering command of a transporter having at least one ground-contacting element, the method comprising:
determining a step gain value of a transporter, the step gain value is set equal to a step on gain value if a rider is stepping on to the transporter or a step off gain value if the rider is stepping off of the transporter;
determining a mount state value of the transporter, the mount state value is based on whether the rider has one or two feet on the transporter;
determining a reduction gain value based on an operation mode value of the transporter, a velocity of the at least one ground-contacting element and the mount state value;
determining a yaw rate reduction gain, the yaw rate reduction gain is the minimum of the reduction gain value and the step gain value; and
determining a transporter steering command based on the yaw rate reduction gain.

21. The method of claim 20, wherein the operation mode value corresponds to one of a beginner mode.

22. The method of claim 20, wherein the step mode value is set equal to the step on gain value if rider detect sensors coupled to the transporter detect when a first foot of the rider is on the transporter and a second foot of the rider is off the transporter.

23. The method of claim 22, wherein the step mode value is set equal to the step off gain value if:
a) rider detect sensors coupled to the transporter detect when a first foot of the rider is on the transporter and a second foot of the rider is off the transporter; and
b) a steering command signal of the transporter is in a direction towards the first foot of the rider that is on the transporter when the steering command signal approaches a value to cause a platform of the transporter to rotate over the second foot.

24. The method of claim 23, wherein determining the step off gain value comprises:
multiplying a side step off gain value by the difference between a current steering command signal and a side step off angle value; and
subtracting a zero angle gain value from the resultant of the multiply.

25. The method of claim 23, wherein determining the side step off gain value comprises:
determining a side step off angle difference value by taking a difference between the zero angle gain value of the transporter and the current steering command signal; and
multiplying the side step off angle difference value by a side step angle value divided by the zero angle gain value.

26. A controller for steering a transporter having at least one ground-contacting element, the controller comprising:
a step mode module to compute a step gain value output, the step gain value output is a step on gain value if a rider is stepping on to the transporter and a step off gain value if the rider is stepping off of the transporter;
a reduction gain module to compute a reduction gain value output based on inputs of an operation mode value of the transporter, a velocity of the at least one ground-contacting element and a mount state, the mount state value is based on whether the rider has one or two feet on the transporter;
a comparator to determine a yaw rate reduction gain value, the yaw rate reduction gain value is the minimum of the reduction gain value and the step gain value; and
a steering module that computes a transporter steering command based on the yaw rate reduction gain value.

27. The controller of claim 26, wherein the operation mode value corresponds to one of a beginner mode.

28. The controller of claim 26, comprising:
rider detect sensors coupled to the transporter to detect when a first foot of the rider is on the transporter and a second foot of the rider is off the transporter to determine the step mode value is a step on gain value.

29. The controller of claim 28, comprising:
a rider detect sensor to detect when a first foot of the rider is on the transporter and a second foot of the rider is off the transporter; and
the step mode module to determine that a steering command signal of the transporter is in a direction towards the first foot of the rider that is off the transporter when the steering command signal approaches a value to cause a platform of the transporter to rotate over the second foot to determine the step mode value is a step off gain value.

30. The controller of claim 29, wherein the step mode module comprises:
a multiplier to multiply a side step off gain by the difference between a current steering command signal and a side step off angle value; and
a subtractor to subtract a zero angle gain value from the resultant of the multiplier to compute the step off gain value.

31. The controller of claim 30, wherein the step mode module comprises:
a side step off angle difference module to determining a side step off angle difference value by taking a difference between the zero angle gain value of the transporter and the current steering command signal; and
a multiplier to multiply the side step off angle difference value by a side step angle value divided by the zero angle gain value to compute the side step off reduction gain scale value.

32. A controller for steering a transporter having at least one ground-contacting element, the controller comprising:
means for determining an initialization roll deadband value based on if an inertial state estimator of the transporter has been initialized;
means for determining a velocity-based roll deadband value based on the velocity of the at least one ground-contacting element;
means for determining a total deadband value based on the velocity-based roll deadband value and the initialization roll deadband value;
means for determining a steering roll value based on a roll angle of the transporter and the total deadband value; and
means for determining a roll compensated steering command signal based on the steering roll value.

33. A method for controlling a steering command of a transporter having at least one ground-contacting element, the method comprising:
determining an initialization roll deadband value based on initialization of a roll state estimator of the transporter;
determining a velocity-based roll deadband value based on a velocity of the at least one ground-contacting element;
determining a total deadband value based on the initialization roll deadband value and the velocity-based roll deadband value; and
determining a roll compensated steering command signal based on the total deadband value.
